(19) United States
(12) Patent Application Publication
(10) Pub. No.: US 2004/0156486 A1
(43) Pub. Date: Aug. 12, 2004

(54) Systems and methods for providing remote telephonic scheduling reminders

(76) Inventors: Cathy Z. Gentry, Birmingham, AL (US); Debra J. Sparks, Birmingham, AL (US)

Correspondence Address: CANTOR COLBURN LLP, 55 GRIFFIN ROAD SOUTH, BLOOMFIELD, CT, 06002, US

(21) Appl. No.: 10/360,378

(22) Filed: Feb. 7, 2003

(51) Int. Cl. H04M 1/64

(52) U.S. Cl. 379/88.22

(57) ABSTRACT

The present invention discloses methods and systems for providing remote reminders and scheduling. The method includes retrieving a record in a database, which is disposed in a first location. The method also includes initiating a call to a first telephone in response to the record and transmitting a first signal to the first telephone. The first signal correlates to the record. The first telephone is disposed in a second location, which is remote from the first location.

### FIELD OF THE INVENTION

The invention generally relates to systems and methods for providing remote telephonic scheduling reminders.

### BACKGROUND

Many systems and methods are known to keep track of schedules, tasks, and appointments. The most basic of these includes recording information on scraps of paper or Post-It Notes®, commonly referred to as “yellow stickies,” and adhering the “stickies” to a surface one is likely to view regularly, such as a desktop, computer monitor screen, or even a refrigerator door. Relying on yellow stickies to keep an appointment, however, requires one to be cognizant of the information recorded on the stickies. Thus, one cannot simply record the scheduling information and keep the appointment without further involvement.

There are many commercially-available pre-printed calendars or date books in which individuals can keep track of schedules, tasks, and appointments. While these date books are more sophisticated, or at least provide greater organization of information than yellow stickies, they nonetheless suffer from the same deficiency. That is, to keep an appointment users of date books cannot simply record the scheduling information without further involvement from the user. Rather, to keep an appointment, date books require one to be cognizant of the information recorded in the date book.

Electronic personal digital assistants (PDAs), personal computers (PCs), and mobile telephones allow one to keep an appointment only by recording the scheduling information into the device. These electronic devices can provide an automatic reminder of the appointment to the user, usually in the form of sound or sensation. While electronic scheduling devices allow one to keep an appointment without being cognizant of the information entered into the device, their effectiveness is limited in that the user must carry the device or have the device in relatively close proximity to feel or hear its automatic reminder. The effectiveness of these electronic devices is further limited in that certain individuals do not make use of these devices. Such individuals include, for example, unsophisticated users, technophobes, and those who may not be able to afford these devices.

### SUMMARY OF THE INVENTION

The present invention comprises systems and methods for providing remote telephonic scheduling reminders. That is, the telephone providing the scheduling reminder is located in a location separate and remote from the database in which the scheduling information is located.

Embodiments of the present invention may take a wide variety of forms. In one exemplary embodiment a method includes retrieving a record in a database. The database is disposed in a first location. The method also includes initiating a call to a first telephone in response to the record and transmitting a first signal to the first telephone. The first telephone is disposed in a second location, which is remote from the first location. The first signal correlates to the record. In another exemplary embodiment, the method includes creating the record in the database.

Another exemplary embodiment includes a computer-readable medium. The computer readable medium has instructions that cause a processor to perform certain steps. These steps include retrieving a record in a database, which is disposed in a first location. The steps also include initiating a call to a first telephone in response to the record and transmitting a first signal to the first telephone. The first telephone is disposed in a second location, which is remote from the first location. The first signal correlates to the record.

In a further exemplary embodiment, a system includes a plurality of communication devices disposed in a first location, a communication network connected to the plurality of communication devices, a processor connected to the communication network, and a database connected to the processor. The database is disposed in a second location, which is remote from the first location. The processor is operative to retrieve a record in the database, initiate a call to one of the plurality of communication devices in response to the record, and transmit a signal to the one of the plurality of communication devices. The signal correlates to the record.

These exemplary embodiments are mentioned not to summarize the invention, but to provide an example of an embodiment of the invention to aid understanding. Exemplary embodiments are discussed in the Detailed Description, and further description of the invention is provided there. Advantages offered by the various embodiments of the present invention may be understood by examining this specification.

### BRIEF DESCRIPTION OF THE DRAWINGS

The accompanying drawings, which constitute part of this specification, help to illustrate embodiments of the invention. In the drawings, like numerals are used to indicate like elements throughout.

FIG. 1 is a schematic of a system according to an embodiment of the present invention.

FIG. 2 is a schematic of the Advanced Intelligent Network of FIG. 1.

FIG. 3 is a block diagram of an embodiment of a method according to the present invention.

### DETAILED DESCRIPTION

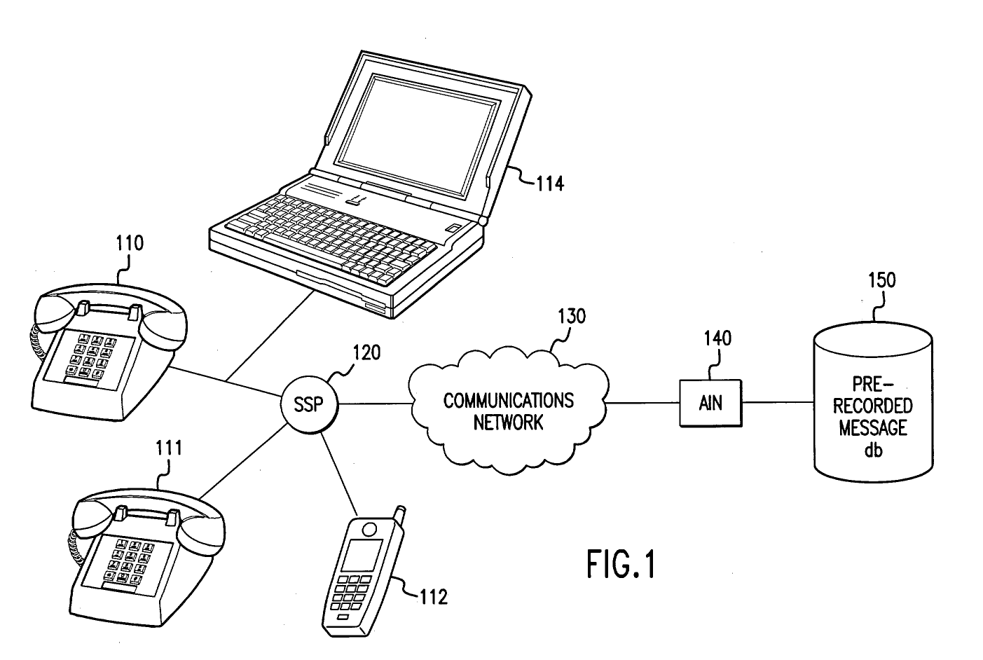

Embodiments of the present invention include systems for providing remote telephonic scheduling reminders. FIG. 1 is a schematic view of a system 100 according to an embodiment of the present invention. The system 100 is preferably implemented in an existing public switched telephone network (PSTN), which includes a plurality of interconnected switches, only one of which is shown, i.e., service switching point (SSP) 120. The system 100 includes a plurality of communication devices 110, 111, 112, 114, SSP 120, a communications network 130, an advanced intelligent network (AIN) 140, and database 150. Preferably, the communication devices include a first landline telephone 110, a second landline telephone 111, a mobile telephone 112, and a computer 114. Alternatively, any other suitable communication devices can be used. Moreover, any other suitable number of communication devices can be used.

The landline telephones 110, 111, the mobile telephone 112, and the computer 114 are connected to the communications network 130. The landline telephones 110, 111 are connected to the communications network 130 through the SSP 120. The SSP 120 is linked to and provides local phone service to the landline telephones 110, 1 11 and the mobile telephone 112.

In the case of the landline telephones 110, 111 the link is a direct landline connection between the landline telephones 110, 111 and the SSP 120. In the case of the mobile telephone 112, the SSP 120 has an associated calling mobile switching center (not shown) connected through landline connections with at least one mobile base station (not shown) for establishing an airwave communication link with the mobile telephone 112. In the case of the computer 114, the link is preferably a direct landline connection with a modem (not shown) connected to the landline telephone 110. Alternatively, the link between the computer 114 and the communications network 130 includes internet cable, satellite, or any other suitable link.

The communications network 130 is preferably the PSTN. Alternatively, the communications network 130 includes the Internet, an intranet, a local area network (LAN), or a wide area network (WAN). Alternatively, any other suitable network can be used. The communications network 130 connects to AIN 140.

AIN components (not shown), suitable for implementing the present embodiment are commercially available and are known to those skilled in the art. AIN components can implement computer readable media (not shown) as known to those skilled in the art. One of the AIN components is an AIN switch that routes calls, recognizes and responds to triggers, and generates queries to obtain call information. AIN 140 preferably includes a network element (not shown) that transfers signaling communications in response to signaling protocols as presently known to those skilled in the art. The network element of AIN 140 enables communication between input devices 110, 111, 112, 114 and the communications network 130.

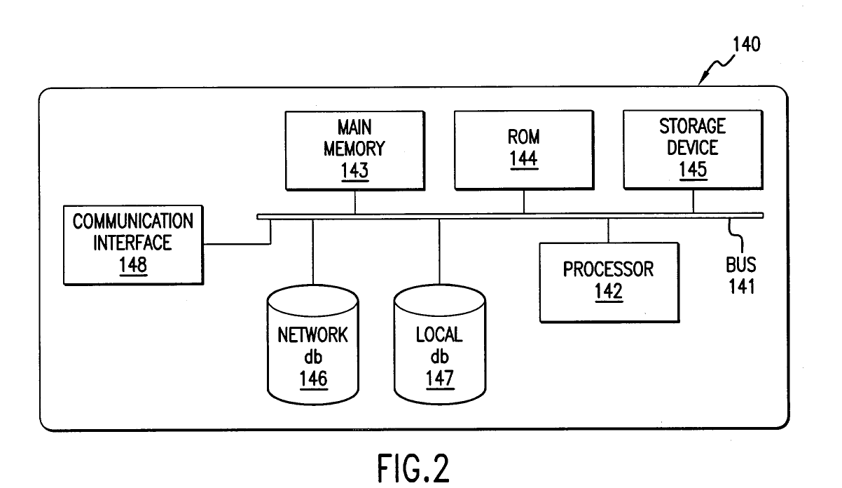

FIG. 2 shows a schematic of AIN 140 according to an embodiment of the present invention. In addition to that described above, AIN 140 includes a bus 141 or other communications medium for communicating information among the components and a processor 142 coupled to bus 141 that processes information. The processor 142 can be any suitable processor or microprocessor that interprets and executes instructions, such as a microprocessor, an Application Specific Integrated Circuit (ASIC), and state machines.

AIN 140 also includes a Random Access Memory (RAM) or other dynamic storage device 143 (i.e., main memory), coupled to bus 141, that stores information and instructions to be executed by processor 142. Main memory 143 also stores temporary variables or other intermediate information used during execution of instructions by processor 142.

AIN 140 also includes a Read Only Memory (ROM) and/or other storage device 140 coupled to bus 141, that stores static information and instructions for processor 142. A data storage device 145 can be coupled to bus 141 to store information and instructions. One embodiment of a suitable computer-readable medium includes an electronic, optical, magnetic, or other storage or transmission device capable of providing processor 142 with computer-readable instructions. Other examples of suitable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. Also, various other forms of computer-readable media may transmit or carry instructions to a computer, including a router, private or public network, or other transmission device or channel.

AIN 140 also includes a network database 146, and a local database 147. The network database 146 stores data related to callers, including associated telephone numbers. Such databases are known in the art. Processor 142 is directly connected to bus 141 to retrieve relevant information from network database 146. In this embodiment, processor 142 is also connected to bus 141 to retrieve relevant information from local database 147.

AIN 140 also includes a communication interface 148, which may include any transceiver-like mechanism that enables AIN 140 to communicate with other devices in system 100.

Referring again to FIG. 1, AIN 140 is connected to database 150. Database 150 are remote from communication devices 110, 111, 112, and 114. Preferably, database 150 includes a series of records having pre-recorded messages. For example, database 150 includes records having messages such as, “it is time to take your medication,” “please return the rented videotape,” and “your library books are due back.”

Database 150 can include any suitable pre-recorded message. Alternatively, instead of messages, database 150 can include distinct telephonic rings. Local database 147 includes records having messages created by the user. While there virtually is no limit to what type of messages can be created, such messages can include, for example, “John, it's time to wake up,” “appointment with Dr. Smith in half-an-hour,” and “time to take second daily dose of blood pressure medication.”

AIN 140 enables a user to create a schedule of appointments, tasks, and reminders. According to one embodiment, the user dials a pre-determined phone number on any of communication devices 110, 111, or 112. Alternatively, the user can type-in a predetermined internet website address on communication device 114. Processor 142 receives information from the user transmitted from any of the communication devices 110, 111, 112, or 114. The signals received by processor 142 cause processor 142 to execute sequences of instructions contained in memory 143.

Such instructions may be read into memory 143 from another computer-readable medium, such as data storage device 145, or from a separate device via communication interface 148. Execution of the sequences of instructions contained in memory 143 causes processor 142 to perform the process steps that will be described below. In alternative embodiments, hardwired circuitry may be used in place of or in combination with software instructions to implement the present invention. Thus, the present invention is not limited to any specific combination of hardware circuitry and software.

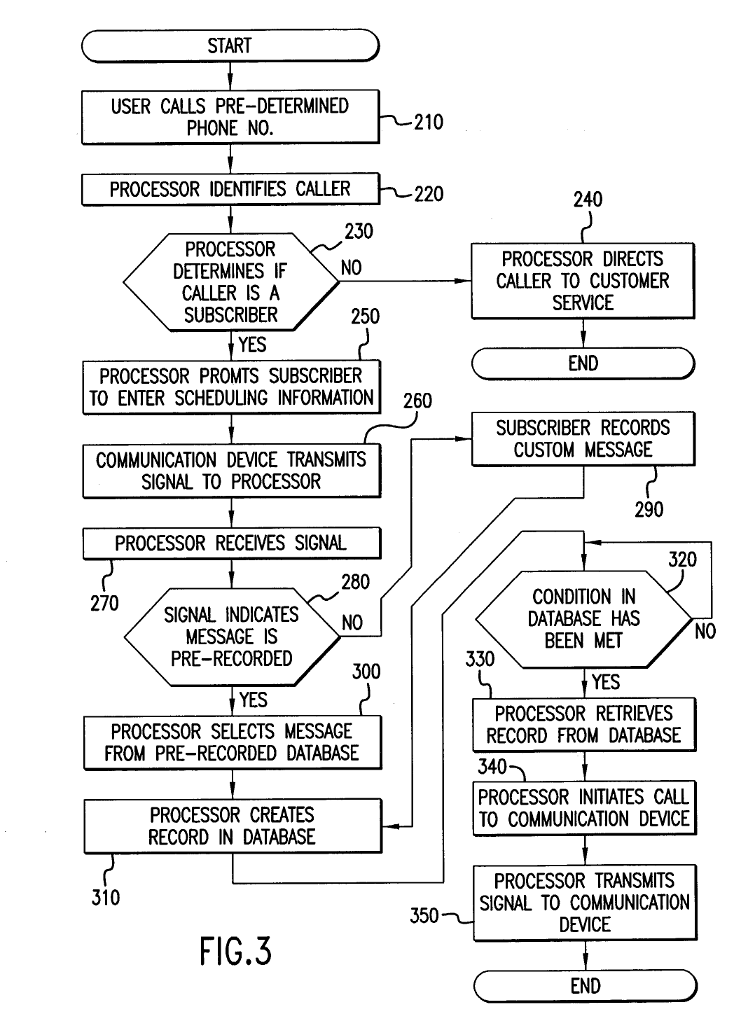

FIG. 3 shows an embodiment of a method 200 of providing remote telephonic scheduling reminders according to an embodiment of the present invention. The method 200 may be employed by the landline telephone 110 described above, and items shown in FIGS. 1 and 2 are referred to in describing FIG. 3 to aid understanding of the embodiment 200 shown. However, embodiments of methods according to the present invention may be employed on a wide variety of devices, in addition to those shown in FIG. 1.

Referring to FIG. 3, as indicated in step 210, a caller calls a pre-determined phone number using landline telephone 110. The next step 220 in the method shown 200 comprises identifying the caller. As described above, processor 142 can compare the calling number with a list of customer telephone numbers in network database 146. Step 230 comprises determining whether the caller is a subscriber to the telephone reminder service. Preferably, the caller is required to enter a telephone number and a personal identification number (PIN). Alternatively, any other suitable means of verifying whether a caller is a subscriber to the service can be used. If the caller is not a subscriber, step 240 in the method 200 shows that the processor 142 directs the caller to contact customer service to subscribe to the telephone reminder service.

If the caller is a subscriber, step 250 describes the processor 142 prompting the subscriber to enter scheduling information. Preferably, the subscriber is prompted to enter scheduling information by commercially available voice menus. Alternatively, any other suitable menus can be used, including web-based graphical user interfaces (GUI). The subscriber is prompted to enter scheduling information based on date, time, occasion, such as a birthday or national holiday, or any other suitable combination.

As described in step 260, the communication device, e.g., the landline telephone 110, transmits a signal to the processor 142. The signal is preferably generated by depressing keys on the telephone keypad or keyboard. Alternatively, the signal can be generated by the subscriber speaking into a telephone. As shown in step 270, the processor receives the signal. According to step 280, the signal indicates whether the subscriber desires to select a pre-recorded message or to record a custom message. Alternatively, the subscriber can select distinct available telephonic rings or tones.

If the signal indicates that the message is not pre-recorded, the subscriber is directed to record a custom message in step 290 shown in the method 200. Otherwise, as shown in step 300, the processor selects a record from a database, e.g., database 150, associated with a pre-recorded message. Once the scheduling information has been selected and an associated message, a record with this information is created in a database, e.g., local database 147.

As shown in step 320, processor 142 will determine periodically whether the record condition in the database has been met. If not, the processor 142 will continue to check at a predetermined frequency. When the condition has been met, the processor 142, as shown in step 330, will retrieve the record from the database.

Step 340 shows that the processor then initiates a call to a communication device. Preferably, the communication device called is the same device from which the subscriber called to create the schedule reminder, e.g., landline telephone 110. Alternatively, the communication device called can be any other communication device, e.g., landline telephone 111, or mobile telephone 112. The processor transmits a signal to the communication device. The signal corresponds to the record in the database and rings the telephone with the chosen ring or plays the pre-recorded or custom message when the call is picked up.

While the present invention has been disclosed with reference to certain embodiments, numerous modifications, alterations, and changes to the described embodiments are possible without departing from the sphere and scope of the present invention, as defined by the appended claims. Accordingly, it is intended that the present invention not be limited to the described embodiments, but that it has the full scope defined by the language of the following claims, and equivalents thereof.

What is claimed is:

1. A method comprising:
retrieving a record in a database, the database disposed in a first location;
initiating a call to a first telephone in response to the record, the first telephone being disposed in a second location, the second location remote from the first location; and
transmitting a first signal to the first telephone, the first signal correlating to the record.

2. The method of claim 1 further comprising creating the record in the database.

3. The method of claim 2, wherein creating the record in the database comprises transmitting a second signal from a communication device to the database.

4. The method of claim 3, wherein the communication device comprises the first telephone.

5. The method of claim 1, wherein the record includes at least one of time, date, and occasion.

6. The method of claim 1, wherein the first signal comprises an audible tone.

7. The method of claim 6, wherein the audible tone comprises a telephonic ring.

8. The method of claim 6, wherein the audible tone comprises a verbal message.

9. A computer readable medium having instructions, the instructions including instructions that cause a processor to perform the steps of:
retrieving a record in a database, the database disposed in a first location;
initiating a call to a first telephone in response to the record, the first telephone being disposed in a second location, the second location remote from the first location; and
transmitting a first signal to the first telephone, the first signal correlating to the record.

10. The computer readable medium of claim 9 further comprising stored instructions, the stored instructions including instructions, that, when executed by the processor cause the processor to perform the step of creating the record in the database.

11. The computer readable medium of claim 10 further comprising stored instructions, the stored instructions including instructions, that, when executed by the processor cause the processor to perform the step of receiving a second signal from a communication device.

12. The computer readable medium of claim 11, wherein the communication device comprises the first telephone.

13. The computer readable medium of claim 9, wherein the record includes at least one of time, date, and occasion.

14. The computer readable medium of claim 9, wherein the signal comprises an audible tone.

15. The computer readable medium of claim 14, wherein the audible tone comprises a telephonic ring.

16. The computer readable medium of claim 14, wherein the audible tone comprises a verbal message.

17. A system comprising:
a plurality of communication devices disposed in a first location;
a communication network connected to the plurality of communication devices;
a processor connected to the communication network; and
a database connected to the processor, the database disposed in a second location remote from the first location, the processor operative to retrieve a record in the database, initiate a call to one of the plurality of communication devices in response to the record, and transmit a signal to the one of the plurality of communication devices, the signal correlating to the record.

18. The system of claim 17, wherein the processor is operative to create the record in the database.

19. The system of claim 17, wherein the record includes at least one of time, date, and occasion.

20. The system of claim 17, wherein the signal comprises an audible tone.

21. The system of claim 20, wherein the audible tone comprises a telephonic ring.

22. The system of claim 20, wherein the audible tone comprises a verbal message.
